(19) United States
(12) Patent Application Publication
(10) Pub. No.: US 2008/0316023 A1
(43) Pub. Date: Dec. 25, 2008

(54) Personal warning system

(76) Inventors: Ronald W. Crowl, Novelty, OH (US); Kathleen B. Dangelo, Novelty, OH (US); Gerald J. Pignolet, Novelty, OH (US); Craig E. Morris, Aurora, OH (US)

Correspondence Address: MCDONALD HOPKINS LLC, 600 Superior Avenue, East, Suite 2100, CLEVELAND, OH, 44114-2653, US

(21) Appl. No.: 12/151,195

(22) Filed: May 5, 2008

Related U.S. Application Data
(60) Provisional application No. 60/927,828, filed on May 4, 2007.

(51) Int. Cl. H04Q 7/00

(52) U.S. Cl. 340/539.13

(57) ABSTRACT

A personal warning system is provided having a receiver associated with a target and capable of receiving a signal, a protective area defined by the target's signal reception, an alarm associated with the target's receiver and capable of alerting the target, and a transmitter associated with an offender and capable of transmitting a signal, wherein the target's alarm is activated when the offender's transmitter remains within the protective area for a predetermined elapsed time.

### CROSS-REFERENCE TO RELATED APPLICATIONS

This application claims benefit to provisional application No. 60/927,828, entitled “BI-DIRECTIONAL WARNING SYSTEM,” filed May 4, 2007, which is hereby incorporated in its entirety by reference.

### FIELD OF THE INVENTION

The present invention relates generally to warning systems and, in particular, to a personal warning system.

### BACKGROUND OF THE INVENTION

When a child is abducted, it is often by a known sex offender or felon. In the United States, there are currently approximately 350,000 registered sex offenders. Accordingly, the judicial system and local governments have implemented a variety of programs to protect society from these criminals.

For example, many communities maintain sexual offender registries and post information including photographs and home addresses of convicted sex offenders on web sites, thereby allowing the public to search for sex offenders living in their community. However, it is up to the public to continuously review the registries. Further, such registries do not protect the public from convicted sex offenders who do not register.

Some communities also require convicted sex offenders to wear a GPS device that records the movements of the sex offender. However, the police generally do not monitor the sex offender's real-time location. Instead, the recorded information is typically transmitted via a modem to the police at the end of the day. Accordingly, neither the police nor the public is provided with the real-time location of the convicted sex offender. Another deficiency of such systems is that a convicted sex offender may not know that he or she is approaching a restricted area, thereby inadvertently exposing him or herself to additional prosecution.

Therefore, some communities have restricted areas where the convicted sex offenders can live, such as school zones. Other cities have even proposed laws that would prevent sex offenders from living within their city limits altogether. However, such measures rely on the convicted sex offender to voluntarily comply with the laws, and do not adequately protect the public.

Other attempts to protect children from sexual predators include products that allow parents to track the location of their children, such as GPS devices built into the child's cell phone. However, such products do not warn the public if a convicted sex offender is nearby. Instead, the devices rely on a parent to discover that the child is missing before tracking the child.

While these and other attempts have been made to increase public awareness of the movement of convicted sex offenders in society, they do not alert the public in real-time that a convicted sex offender is nearby. Further, such attempts do not provide adequate notice to the convicted sex offender that he or she is entering a restricted area. Therefore, a need exists for a near real-time warning system for warning the public that a convicted sex offender is nearby. In addition, a need exists for a warning system capable of alerting a convicted sex offender if he or she is approaching a restricted area.

Additional information will be set forth in the description which follows and in part will be obvious from the description or may be learned by practice of the invention.

### SUMMARY OF THE INVENTION

A personal warning system is provided having a receiver associated with a target and capable of receiving a signal, a protective area defined by the target's signal reception, an alarm associated with the target's receiver and capable of alerting the target, and a transmitter associated with an offender and capable of transmitting a signal, wherein the target's alarm is activated when the offender's transmitter remains within the protective area for a predetermined elapsed time.

In another aspect, a personal warning system is provided having a transceiver associated with a target and capable of sending and receiving a signal, a protective area defined by the target's signal reception, an alarm associated with the target's receiver and capable of alerting the target, and a transmitter associated with an offender and capable of transmitting a signal, wherein the target's alarm is activated when the offender's transmitter remains within the protective area for a predetermined elapsed time.

In yet another aspect, a method for a personal warning system is provided, having the steps of associating a transceiver with an offender, associating a transceiver with a target, transmitting a signal from said offender's transceiver, transmitting a signal from said target's transceiver to define a protective area, receiving the offender's signal at the target's transceiver, receiving the target's signal at the offender's transceiver, alerting the offender upon the offender's transceiver entering the protective area, and alerting the target if the offender's transceiver remains within the protective area for a predetermined elapsed time.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE SEVERAL VIEWS OF THE DRAWINGS

Objects and advantages, together with the operation of the invention, may be better understood by reference to the following detailed description taken in connection with the following illustrations, wherein:

FIG. 1 is a schematic view of one embodiment of the personal warning system of the present invention.

FIG. 2 is a perspective view of a emitter in an embodiment of the present invention.

FIG. 3 is a perspective view of a receiver in an embodiment of the present invention.

FIG. 4 is a schematic view of an embodiment of the personal warning system.

FIG. 5 is a schematic view of a hardware platform in an embodiment of the present invention.

FIG. 6 is a schematic view of a hardware platform with a USB controller in an embodiment of the present invention.

FIG. 7 is a diagrammatical view of programming an emitter in an embodiment of the present invention.

FIG. 8 is a schematic view of an emitter positioned outside of a protective area of a receiver in an embodiment of the present invention.

FIG. 9 is a schematic view of an emitter positioned within a predetermined area of a receiver in an embodiment of the present invention.

FIG. 10 is a diagrammatical view of a monitoring application in an embodiment of the present invention.

FIG. 11 is a schematic view of a stationary receiver in an embodiment of the present invention.

FIG. 12 is a schematic view with a supervisory receiver in an embodiment of the present invention.

FIG. 13 is a schematic view with a supervisory receiver in an embodiment of the present invention.

FIG. 14 is a schematic view of an emitter entering a protective area of a plurality of receivers in an embodiment of the present invention.

### DETAILED DESCRIPTION OF THE PREFERRED EMBODIMENTS

While the present invention is described with reference to embodiments described herein, it should be clear that the present invention is not limited to such embodiments. Therefore, the description of the embodiments herein is merely illustrative of the present invention and will not limit the scope of the invention as claimed.

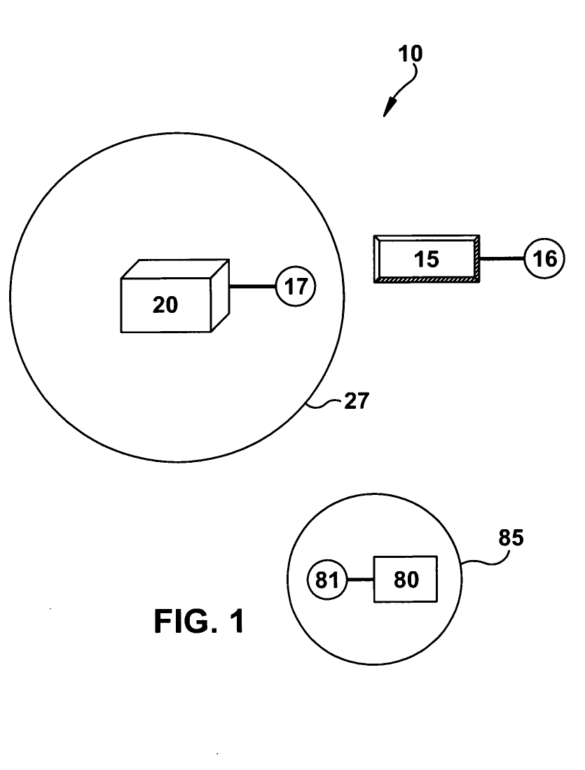

Referring now to the drawings and in particular to FIG. 1, a personal warning system 10 (hereinafter “the warning system 10”) is provided with an emitter 15 and a receiver 20. If an offender 16 associated with the emitter 15 enters a predetermined radius 27 of the receiver 20, the offender 16 may be warned. If the offender 16 remains within the predetermined radius 27 for a predetermined amount of time, a target 17 associated with the receiver 20 is warned. Optionally, a supervisory receiver 80 associated with a supervisor 81 may also be provided.

The offender 16 may be a person convicted of a crime including, but not limited to, molestation, rape, murder, and assault. In a preferred embodiment, the offender 16 is a convicted sexual predator or child molester. The target 17 and the supervisor 81 may be any person such as a parent or child, or stationary objects such as homes, schools, daycare centers, and the like.

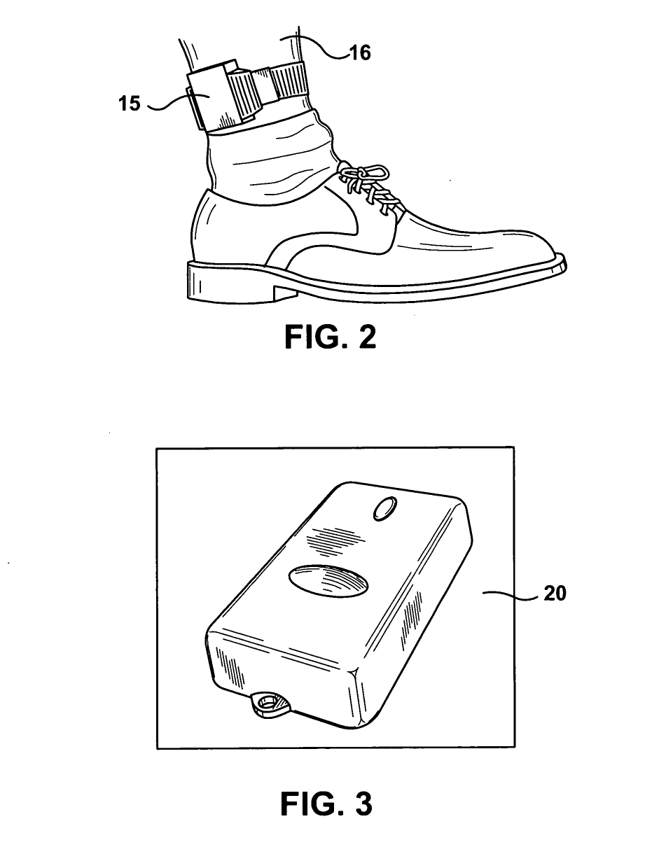

The emitter 15 may be any device capable of transmitting a first signal to the receiver 20 and the supervisory receiver 80. The first signal may convey the proximity of the emitter 15 and contain encoded information about the offender 16. In an embodiment, the emitter 15 may be a transceiver capable of sending a signal and receiving a signal. For example, the emitter 15 may be capable of receiving a signal from the receiver 20 and the supervisory receiver 80. In an illustrative example, as shown in FIG. 2, the emitter 15 may be an ankle bracelet similar to existing GPS devices that convicted criminals must wear while on parole or house arrest.

The receiver 20 may be any device capable of receiving the first signal from the emitter 15 and a third signal from the supervisory receiver 80. In an embodiment, the receiver 20 is a transceiver capable of receiving a signal and transmitting a signal. For example, the receiver 20 may be capable of transmitting a second signal to convey the proximity of the receiver 20 to the emitter 15 and supervisory receiver 80. It is to be understood that the receiver 20 may be stationary or portable. As shown in FIG. 3, the receiver 20 may be a fob that can be clipped on a child's book bag, belt loop, or clothing. It is to be understood however, that one of ordinary skill in the art will appreciate that the receiver 20 may be provided in a variety of forms such as watches, necklaces, bracelets, cell phones, and the like.

The supervisory receiver 80 may be any device capable of receiving the first signal and the second signal. In an embodiment, the supervisory receiver 80 is a transceiver capable of transmitting a signal and receiving a signal. For example, the supervisory receiver 80 may transmit a third signal to convey the proximity of the supervisory receiver 80 to the emitter 15 and the receiver 20. The supervisory receiver 80 may be provided with a directional indicator (not shown) to indicate the direction from which the first signal or second signal is being transmitted. In a non-limiting example, the directional indicator may include a plurality of light emitting diodes (LEDs) shaped as an arrow to indicate the location of the emitter 15 or the receiver 20. Further, it is to be understood that the directional indicator may be capable of indicating the direction of both the emitter 15 and the receiver 20.

A proximity indicator (not shown) may also be provided to indicate the proximity of the supervisory receiver 80 to the receiver 20. For example, the proximity indicator may include a plurality of LEDs that light up as the supervisory receiver 80 approaches the receiver 20. Accordingly, the supervisor 81 may follow and locate the receiver 20, even when the receiver 20 is out of sight. It is to be understood that the supervisory receiver 80 may be, but is not limited to, a fob that can be clipped on a bag, belt loop, or clothing.

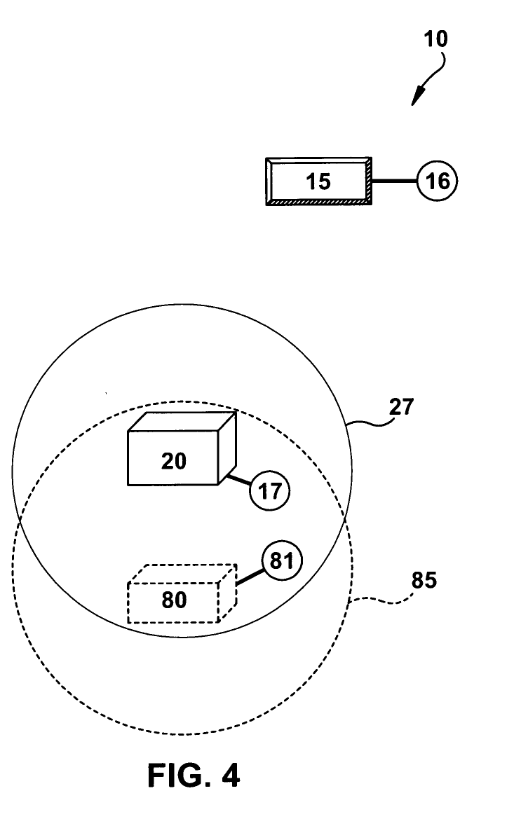

As shown in FIG. 4, the emitter 15, the receiver 20, and the supervisory receiver 80 may transmit any type of wireless signal. The first signal, the second signal, and the third signal may be transmitted continuously, periodically, or in response to another signal. In an illustrative example, the signals may be transmitted at a frequency band not controlled by the FCC, such as worldwide unlicensed bands at the following frequencies: 2.400-2.484 GHz, 902-928 MHz and 868.0-868.6 MHz. It is to be understood, however, that one of ordinary skill in the art will appreciate that a variety of frequencies may be used within the scope of the present warning system 10. An advantage of the present system is that it does not require a GPS system to provide a real-time (or substantially a real-time) warning to the offender 16, target 17, and supervisor 81. However, it is to be understood that the emitter 15, the receiver 20, and the supervisory receiver 80 may include a GPS device to monitor the location of each. It is also to be understood that the emitter 15, the receiver 20, and the supervisory receiver 80 may be incorporated into any wireless device including, but not limited to, cell phones, blackberries, and the like.

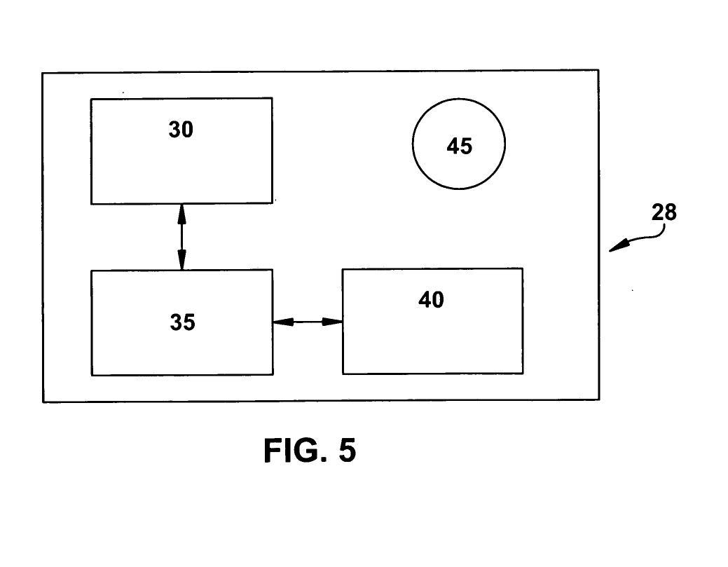

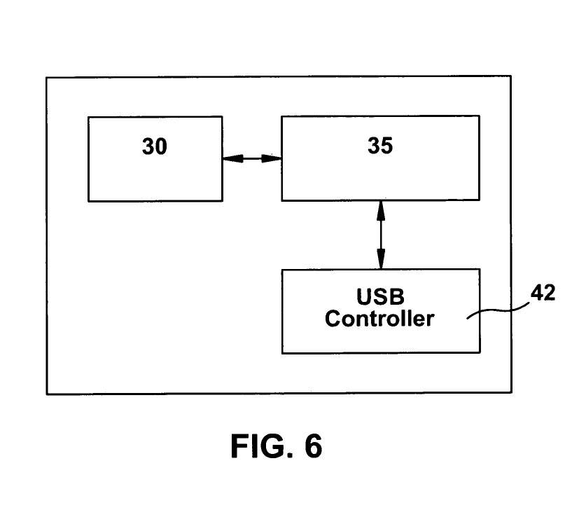

The hardware for the emitter 15, the receiver 20, and the supervisory receiver 80 may be the same. In a non-limiting example, the hardware may be based on ZigBee wireless technology. As shown in FIG. 5, the hardware platform 28 may include, but is not limited to, four subassemblies. As shown in FIG. 6, there may also be a USB device 42 to provide the communication gateway between the emitter 15, the receiver 20, and the supervisory receiver 80, and a variety of software applications. It is to be understood that a USB controller may handle any PC to USB device 42 communications.

As shown in FIG. 5, a modem 30 is provided for transmitting and receiving messages or signals from other modems, such as ZigBee modems. The ZigBee modem is a wireless technology device for low-cost, low-power, wireless sensor networks that utilizes an IEEE 802.15.4 physical radio specification. However, the hardware platform 28 should not be deemed as limited to any specific wireless technology or modem. One of ordinary skill in the art will appreciate the use of any wireless technology for the warning system 10.

A microcontroller 35 may be provided to control the transmission of signals and interpret the received signals from the modem 30. The microcontroller 35 may also control an alarm 40. The alarm 40 provides a warning to the offender 16, the child 17, or the supervisor 81, as required by the application. The alarm 40 may be visual (such as a flashing light), auditory, vibratory, or any combination thereof. The software downloaded to the microcontroller may determine if the device operates as the emitter 15, the receiver 20, or the supervisory receiver 80. Typically, a battery 45 is provided for powering the emitter 15, the receiver 20, and the supervisory receiver 80.

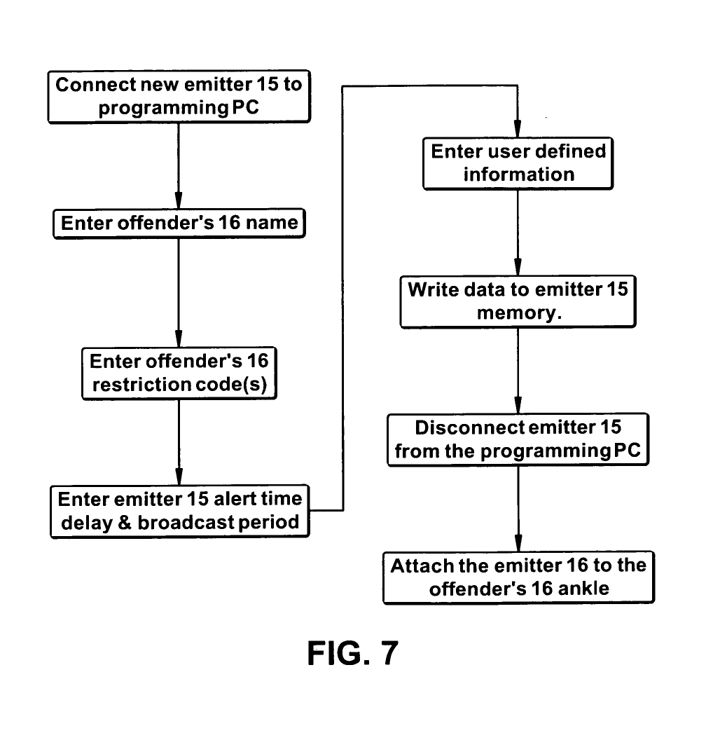

In an illustrative example, .NET technologies may be used for PC-based applications. It is to be understood that the communications between the emitter 15, the receiver 20, the supervisory receiver 80, and associated applications may be encrypted to ensure the security and privacy of the transmissions. With respect to programming applications, the software running in the microcontroller 35 of the emitter 15, the receiver 20, and supervisory receiver 80 may be standard, non-customized software and may be programmed during manufacture. It is to be understood, however, that an application may be provided for programming the emitter 15 to input offender-specific information, as shown in FIG. 7.

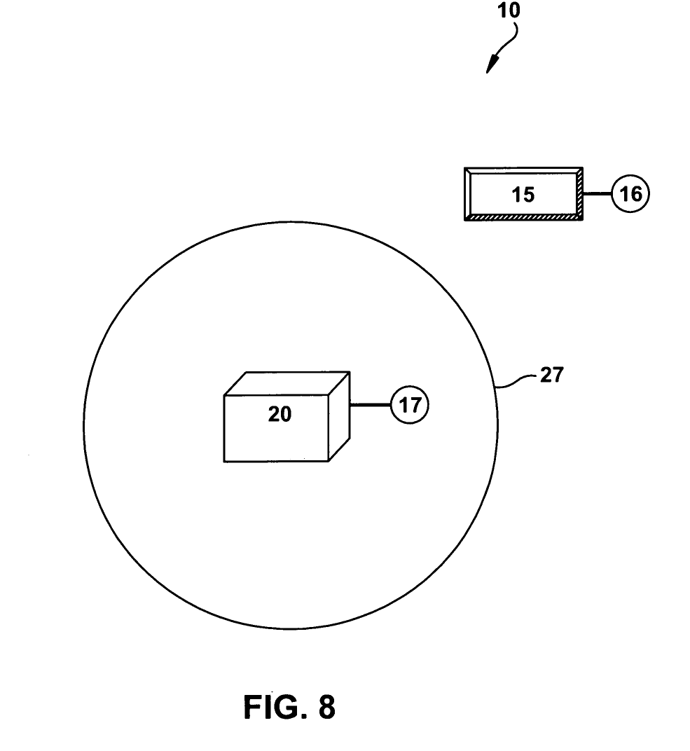

In an illustrative example, as shown in FIG. 8, if the emitter 15 remains outside the predetermined radius 27 (hereinafter referred to as “the protective area 27”), the alarm 40 of the receiver 20 is not activated to warn the child 17 that the offender 16 is nearby. It is to be understood that the protective area 27 may be of any size. For example, the protective area 27 may be defined by the reception strength of the receiver 20. The protective area 27 may also be based on the strength of the first signal. For example, the receiver 20 may transmit the second signal in response to a first signal of a predetermined strength (which occurs at a specified distance). It is to be understood, however, that if the receiver 20 is capable of transmitting a signal, the protective area 27 may be defined by the strength of the receiver's signal.

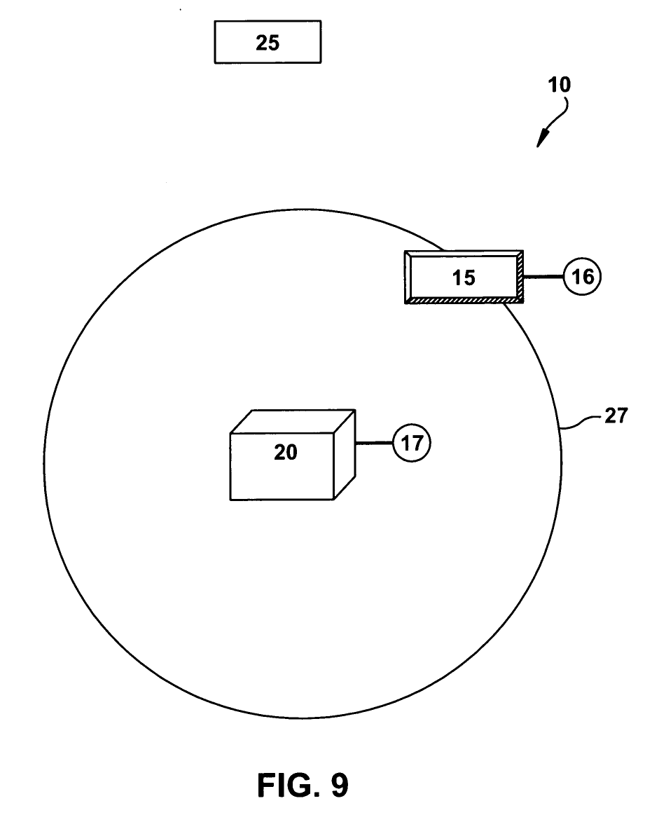

As shown in FIG. 9, as the emitter 15 enters the protective area 27 the receiver 20 receives the emitter's 15 signal. If, after a predetermined elapsed time, the receiver 20 continues to receive the emitter's 15 signal, the alarm of the receiver 20 is activated to warn the child 17 that the offender 16 is nearby. It is to be understood that the emitter 15, the receiver 20, and the supervisory receiver 80 may be provided with a memory for recording such incidents for later review in the emitter 15, the receiver 20 and the supervisory receiver 80. A signal may also be transmitted to a police department and/or parole officer to report the incident.

In another embodiment, also shown in FIG. 8, the emitter 15 and the receiver 20 may be transceivers capable of transmitting a signal and receiving a signal. If the emitter 15 remains outside of the protective area 27, the alarm 40 of the receiver 20 is not activated and the receiver 20 does not transmit the second signal.

As shown in FIG. 9, as the emitter 15 enters the protective area 27 and the receiver 20 receives the first signal and transmits the second signal. Upon receiving the second signal (or a predetermined elapsed time thereafter), the alarm 40 of the emitter 15 is activated to warn the offender 16 that the offender 16 must exit the protective area 27. If, after a predetermined elapsed time, the receiver 20 continues to receive the first signal, the alarm 40 of the receiver 20 is activated to warn the child 17 that the offender 16 is nearby. Such incidents may be recorded for later review in the emitter 15 and the receiver 20. A signal may also be transmitted to a police department and/or parole officer to report the incident.

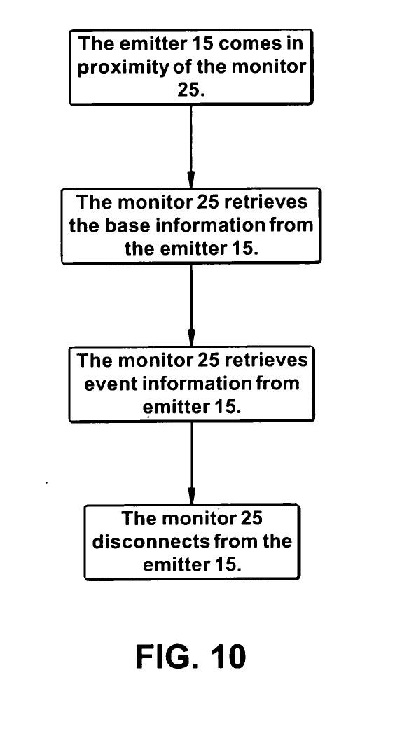

As shown in FIG. 9, a monitor 25 may also be provided for monitoring the activity of the offender 16. The monitor 25 may communicate with the emitter 15, as shown in FIG. 10, to obtain information from it. This information may include the base information from the emitter 15, including the offender's 16 name, restriction codes, time delays, etc. The monitor 25 may also receive the number of successful/unsuccessful “events” that the offender 16 has been exposed to. Successful events may include incidents in which the offender 16 is warned and successfully leaves a predetermined radius 27 before the receiver's alarm 40 is triggered. Unsuccessful events may be defined as incidents in which the offender 16 does not leave the protective area 27, thereby triggering the receiver's alarm 40. The information may be useful for parents, law enforcement officials, and parole officers. A monitor 25 may also be provided to download and review incidents recorded in the receiver 20 and the supervisory receiver 80.

It is understood that the monitor 25 may be portable or stationary. For example, a parole officer may carry it when checking on offenders 16 or a parent may carry it to check on a child 17. In another embodiment, the offender 16 may be required to periodically report to a stationary monitor 25 that retrieves the information, thereby reducing the amount of human supervision required. It is also understood that the monitor 25 may utilize the same hardware and software technology as the emitter 15, the receiver 20, and the supervisory receiver 80.

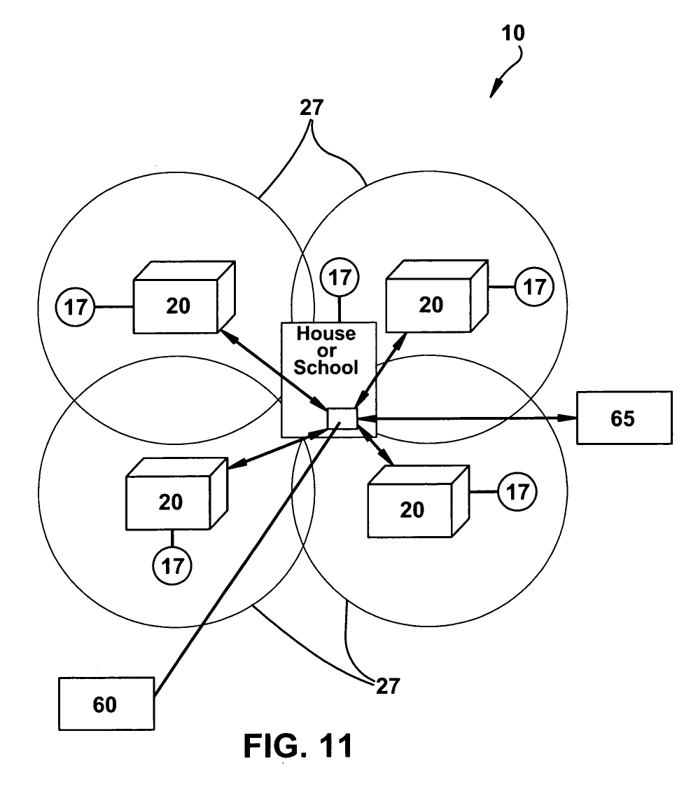

In an illustrative example, the receiver 20 may be stationary, such as at a home, school, playground, library, park, and the like. As shown in FIG. 11, multiple receivers 20 may be networked to provide a larger protective area 27 that may cover an entire home or school. As shown, the receiver 20 may be interfaced with a home security 60 and/or a commercial monitoring system 65 to provide additional protection. For example, if an offender 16 remains within the protective area 27 for a predetermined elapsed time, the target 17 associated with the receiver 20 may be alerted to the presence of the offender 16. In addition, the home security 60 and/or the commercial monitoring system 65 may also be triggered.

FIGS. 1, 12, and 13 illustrate an embodiment of the warning system 10 including the supervisory receiver 80. The supervisory receiver 80 transmits the third signal within a predetermined radius 85 (hereinafter referred to as “the supervisory area 85”). While the receiver 20 remains within the supervisory area 85, the receiver 20 alarm 40 may be disabled. It is to be understood that the supervisory receiver 80 may be programmed to only disable the alarm 40 of a receiver 20 associated with the supervisory receiver 80. As with the protective area 27 for the receiver 20, the supervisory area 85 may be of any predetermined distance.

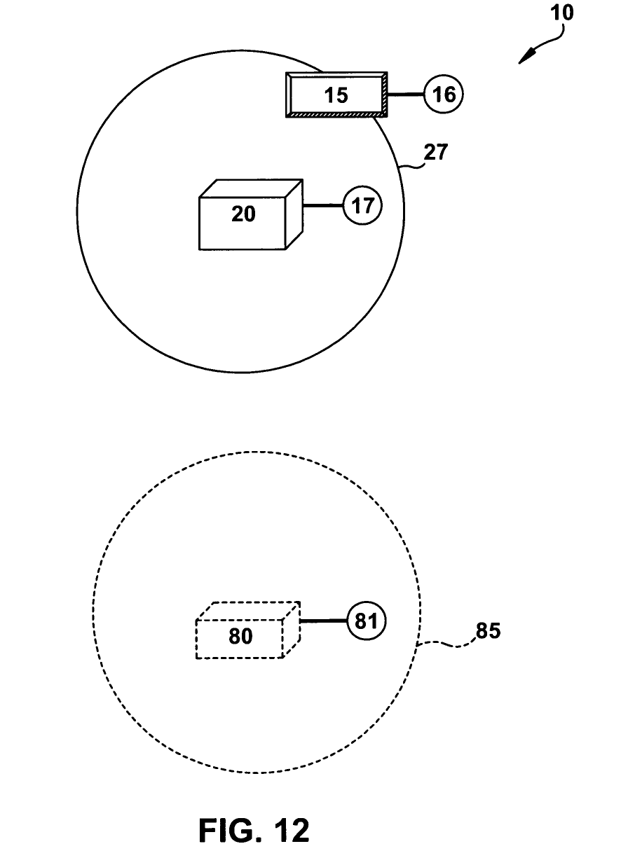

As shown in FIG. 12, when the receiver 20 is positioned outside of the supervisory zone 85 and the emitter 15 enters the protective area 27, the warning system 10 may operate as described above. If instead, the emitter 15 enters the supervisory area 85 (not shown), the supervisory receiver 80 may operate in the same manner as the receiver 20, as described above. The incident may be recorded in each the emitter 15, the receiver 20, and the supervisory receiver 80.

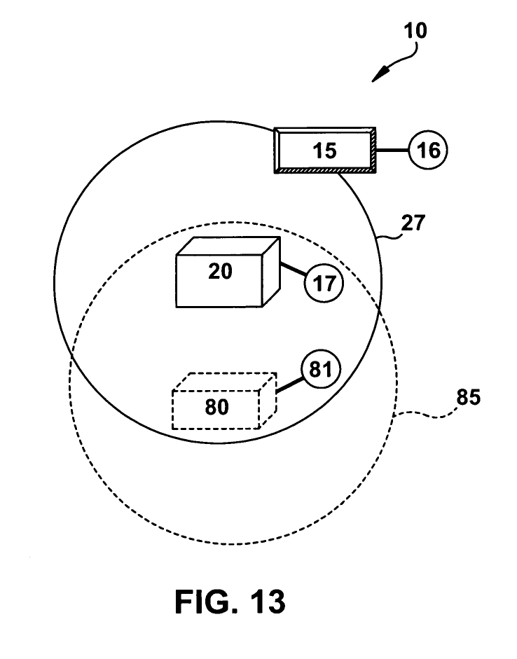

As shown in FIG. 13, if the emitter 15 enters the protective area 27 while the receiver 20 is in the supervisory zone 85, the receiver 20 transmits the second signal. The second signal is received by the emitter 15 so that the offender 16 is warned by the alarm 40 to leave the protective area 27. The supervisory receiver 80 also receives the second signal. If the offender 16 remains within the predetermined area 27, the alarm 40 on the supervisory receiver 80 is activated to alert the supervisor 81 that the offender 16 is nearby. The incident may be recorded in each the emitter 15, the receiver 20, and the supervisory receiver 80.

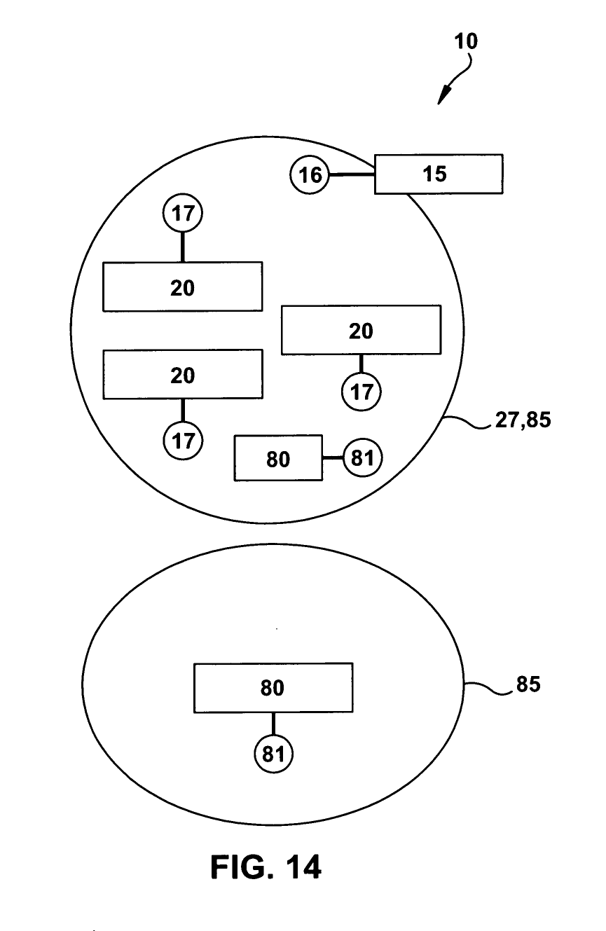

In another embodiment, the alarm 40 may be disabled on the emitter 15, the receiver 20, the supervisory receiver 80, or any combination thereof, if a predetermined number of receivers 20 and/or supervisory receivers 80 are within a predetermined area. As shown in FIG. 14, if the protective areas 27 and supervisory areas 85 overlap, the alarms 40 on the emitter 15, the receiver 20, and the supervisory receiver 80 may be disabled. This will allow the offender 16 to enter such areas without constantly triggering the alarms 40. However, this density feature may not apply in all situations. For example, the alarms 40 for the emitter 15, receiver 20, and supervisory receiver 80 may not be disabled if the offender 16 is on house arrest, or if one of the receivers 20 is a stationary device located at a school, daycare center, or a part of a home security system.

Although the preferred embodiment of the present invention has been illustrated in the accompanying drawings and described in the foregoing detailed description, it is to be understood that the present invention is not to be limited to merely the preferred embodiments disclosed but that the invention described herein is capable of numerous rearrangements, modifications, and substitutions without departing from the scope of the claims hereafter.

We claim:

1. A personal warning system comprising:
a receiver associated with a target and capable of receiving a signal;
a protective area defined by the target's signal reception;
an alarm associated with the target's receiver and capable of alerting the target;
a transmitter associated with an offender and capable of transmitting a signal; and
wherein the target's alarm is activated when the offender's transmitter remains within the protective area for a predetermined elapsed time.

2. The personal warning system of claim 1 further comprising:
a transmitter associated with the target and capable of transmitting a signal;
a receiver associated with a supervisor and capable of receiving a signal;
a supervisory area defined by the supervisor's signal reception; and
an alarm associated with the supervisor's receiver and capable of alerting the supervisor;
wherein the supervisor's alarm is activated when the offender's transmitter remains within the supervisory area for a predetermined elapsed time.

3. The personal warning system of claim 2 further comprising:
a transmitter associated with the supervisor and capable of transmitting a signal;
wherein said target's alarm is disabled when the supervisor's transmitter remains within the protective area.

4. The personal warning system of claim 1 further comprising a memory associated with the target's receiver capable of storing data regarding entry of the offender's transmitter into the protective area and elapsed time therein.

5. The personal warning system of claim 4 further comprising a monitoring device capable of receiving said data from the target's memory.

6. The personal warning system of claim 5 wherein the target's receiver, transmitter, and alarm are associated with the target such that they are on the target, or located near the target.

7. The personal warning system of claim 6 wherein the target's receiver, transmitter, and alarm are part of a fob.

8. A personal warning system comprising:
a transceiver associated with a target and capable of sending and receiving a signal;
a protective area defined by the target's signal reception;
an alarm associated with the target's receiver and capable of alerting the target;
a transmitter associated with an offender and capable of transmitting a signal; and
wherein the target's alarm is activated when the offender's transmitter remains within the protective area for a predetermined elapsed time.

9. The personal warning system of claim 8 further comprising:
a receiver associated with the offender capable of receiving a signal; and
an alarm associated with the offender's transceiver and capable of alerting the offender;
wherein the offender's alarm is activated when the offender's receiver enters the target's protective area and receives a signal from the target's transceiver.

10. The personal warning system of claim 9 further comprising a directional indicator associated with the offender's transceiver capable of leading said offender away from said protective area or said supervisory area.

11. The personal warning system of claim 8 further comprising:
a transceiver associated with a supervisor and capable of sending and receiving a signal;
a supervisory area defined by the supervisor's signal reception;
an alarm associated with the supervisor's receiver and capable of alerting the supervisor; and
wherein the supervisor's alarm is activated when the offender's transmitter remains within the supervisory area for a predetermined elapsed time.

12. The personal warning system of claim 11 wherein said target's alarm is disabled when the target's transmitter remains within the supervisory area.

13. The personal warning system of claim 11 further comprising a directional indicator associated with the supervisory transceiver for indicating the direction from which the target's signal is transmitted.

14. The personal warning system of claim 11 wherein the target's alarm, the supervisor's alarm, and the offender's alarm are disarmed if the offender's transceiver enters a predetermined number of overlapping protective areas or supervisory areas.

15. The personal warning system of claim 9 further comprising a memory associated with said offender's transceiver capable of storing data regarding entry of said offender's transceiver into the protective area and elapsed time within the protective zone.

16. The personal warning system of claim 15 further comprising a monitoring device capable of receiving said data.

17. The personal warning system of claim 9 wherein said target's transceiver is associated with the target such that it is located on or near the target.

18. A method for a personal warning system, comprising the steps of:
associating a transceiver with an offender;
associating a transceiver with a target;
transmitting a signal from said offender's transceiver;
transmitting a signal from said target's transceiver to define a protective area;
receiving the offender's signal at the target's transceiver;
receiving the target's signal at the offender's transceiver;
alerting the offender upon the offender's transceiver entering the protective area; and
alerting the target if the offender's transceiver remains within the protective area for a predetermined elapsed time.

19. The method of claim 18 further comprising the steps of:
associating a transceiver with a supervisor;
transmitting a signal from said supervisor's transceiver to define a supervisory area;
receiving the offender's signal at the supervisor's transceiver;
alerting the offender upon the offender's transceiver entering the supervisory area; and
alerting the supervisor if the offender's transceiver remains within the supervisory area for a predetermined elapsed time.

20. The method of claim 18 further comprising the steps of:
receiving the target's signal at the supervisor's transceiver;
receiving the supervisor's signal at the target's transceiver; and
disabling the target's alarm while the target's transceiver remains within the supervisory area.
